(19) United States
(12) Patent Application Publication
(10) Pub. No.: US 2026/0141762 A1
(43) Pub. Date: May 21, 2026

(54) Front lock body structure having integrated antennas

(71) Applicant: XTHINGS INDUSTRY LLC, Fremont, CA (US)

(72) Inventor: Lingling Qian, Fremont, CA (US)

(73) Assignee: XTHINGS INDUSTRY LLC, Fremont, CA (US)

(21) Appl. No.: 19/281,674

(22) Filed: Jul. 27, 2025

(51) Int. Cl. G07C 9/00; H01Q 1/22; H01Q 21/28

(52) U.S. Cl. CPC G07C 9/00309; H01Q 1/22; H01Q 21/28; G07C 2009/00769

(57) ABSTRACT

The present invention relates to the technical field of smart locks, specifically disclosing a front lock body structure having integrated antennas, comprising an external panel on the front lock body; a PCB board mounted inside the front lock body adjacent to the panel, equipped with a Bluetooth antenna; a circular NFC antenna arranged on the panel; a UWB antenna positioned above the center of the NFC antenna's circular configuration. By rationally positioning the UWB, NFC, and Bluetooth antennas within corresponding locations on the front lock body; the limited internal cavity space without enlarging the lock body's dimensions is utilized, precise inter-antenna distances to prevent mutual interference is maintained, meeting interference threshold requirements, co-existence and optimal functionality of all antennas while occupying minimal space is enabled and zero co-frequency interference and efficient spatial utilization is achieved.

### TECHNICAL FIELD

The present invention relates to the technical field of smart locks, specifically a front lock body structure having integrated antennas.

### BACKGROUND TECHNOLOGY

In the fields of intelligent locks, wireless communication remains a basic function, a hardware basis for wireless communication is to provide wireless communication and sensing apparatuses on the front and rear lock bodies of the intelligent locks currently available, and these devices combine existing terminals and wireless technologies to adapt to and satisfy communication, unlocking and locking of the intelligent locks and operation preferences of users.

In modern smart locks, the rapid technological iteration and expanding application scenarios have driven the integration of various communication and intelligent technologies. For instance, combined application of NFC (Near Field Communication antennas), UWB (Ultra-Wideband antennas), and Bluetooth antenna communication can meet diverse user needs across scenarios, making door access more efficient, user-friendly, and intelligent. However, the limited hardware space within smart locks presents challenges. As additional antennas are incorporated, greater internal space becomes necessary, implicitly demanding more structural room and elevating design complexity. Moreover, since UWB, NFC, and Bluetooth differ in frequency and characteristics, potential antenna interference may arise, further compounding design challenges.

Based on the above considerations, the present invention designs a front lock body structure having integrated antenna. By strategically positioning UWB, NFC, and Bluetooth antennas on the front lock body, rational antenna placement within limited space is achieved while avoiding mutual interference between the antennas. This enables each antenna to leverage its respective strengths, providing a foundation for enhanced intelligence and expanded performance capabilities in smart locks.

### SUMMARY OF INVENTION

Based on the above considerations, the objective of the present invention is to overcome the shortcomings of existing technologies by providing a front lock body structure having integrated antenna. Through rational placement of UWB, NFC, and Bluetooth antennas on the front lock body, this design achieves optimal antenna configuration within limited space while preventing mutual interference. This allows each antenna to leverage its full potential, thereby supporting the enhancement of intelligence and performance expansion in smart locks.

To achieve this objective, the present invention provides a front lock body structure having integrated antennas, comprising:
a front lock body with an external panel;
a PCB board mounted inside the front lock body on the inner side of the panel, equipped with a Bluetooth antenna;
a circular NFC antenna arranged on the panel;
a UWB antenna positioned above the center of the NFC antenna's circular arrangement;
a card authentication mark marked on the panel at the location of the UWB antenna;
wherein the NFC antenna is electrically connected to the PCB board; the UWB antenna is mounted on a separate PCB board and electrically connected to the PCB board housing the Bluetooth antenna; a distance between the NFC antenna and the Bluetooth antenna ranges from 11 mm to 12 mm, while the distance between the NFC antenna and the UWB antenna is 1 mm to 2 mm; a distance between the Bluetooth antenna and the UWB antenna is 13 mm to 14 mm.

A button is installed on the panel outside the circular NFC antenna.

The Bluetooth antenna is positioned adjacent to the button.

A lock cylinder is housed below the panel inside the front lock body, and a keyhole is provided in the front lock body.

A transmission rod is internally connected to the lock cylinder.

A radar sensor is integrated at a bottom of the panel inside the front lock body.

Advantages of the present invention over existing technologies are: compared with existing solutions, the present invention rationally positions UWB, NFC, and Bluetooth antennas within the front lock body, utilizing the limited internal cavity space without enlarging the lock body's overall dimensions. By precisely controlling inter-antenna distances, mutual interference is eliminated while meeting interference threshold requirements. This enables co-existence and optimal functionality of all antennas within minimal space, achieving zero co-frequency interference and efficient spatial utilization.

### BRIEF DESCRIPTION OF DRAWINGS

FIG. 1 is a structural schematic diagram showing a front lock body of the present invention.

FIG. 2 is a schematic diagram showing a front portion of a panel of the present invention.

Marks in the drawings are: 1 Bluetooth antenna; 2 NFC antenna; 3 UWB antenna; 4 front lock body; 5 lock cylinder; 6 radar sensor; 7 PCB board; 8 transmission rod; 9 interface; 10 key hole; 11 button; and 12 card authentication mark.

### EMBODIMENTS

Based on the accompanying drawings, the present invention is further described below.

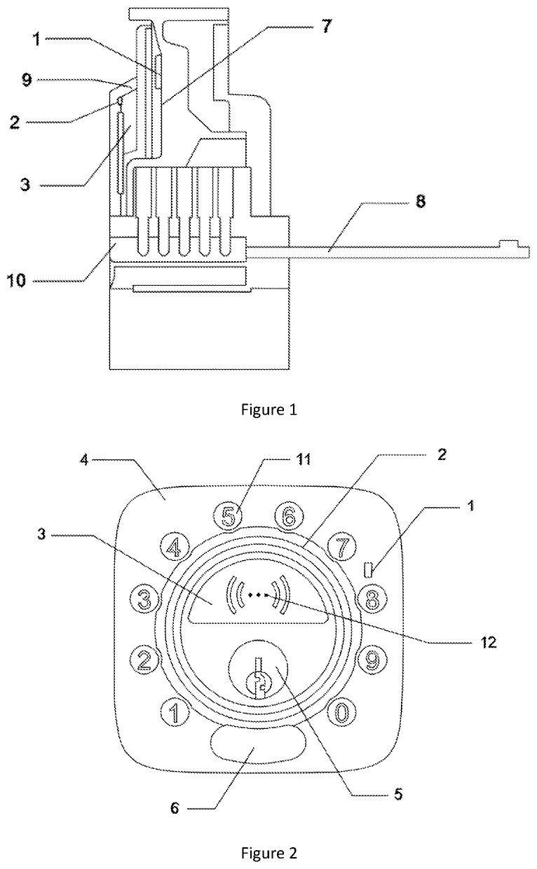

With reference to FIGS. 1-2, the present invention provides a front lock body structure having integrated antennas, comprising:
a front lock body 4 with an external panel 9;
a PCB board 7 mounted inside the front lock body 4 on the inner side of the panel 9, equipped with a Bluetooth antenna 1;
a circular NFC antenna 2 arranged on the panel 9;
a UWB antenna 3 positioned above the center of the circular NFC antenna 2;
a card authentication mark 12 marked on the panel 9 at the location of the UWB antenna 3; wherein
the NFC antenna 2 is electrically connected to the PCB board 7; the UWB antenna 3 is mounted on an independent PCB board and electrically connected to the PCB board 7 housing the Bluetooth antenna 1; a distance between the NFC antenna 2 and the Bluetooth antenna 1 ranges from 11 mm to 12 mm, while the distance between the NFC antenna 2 and the UWB antenna 3 is 1 mm to 2 mm; a distance between the Bluetooth antenna 1 and the UWB antenna 3 is 13 mm to 14 mm.

Additionally:

A button 11 is installed on the panel 9 outside the circular NFC antenna 2.

The Bluetooth antenna 1 is positioned adjacent to the button 11.

A lock cylinder 5 is housed below the panel 9 inside the front lock body 4, which includes a keyhole 10.

A drive rod 8 is internally connected to the lock cylinder 5.

A radar sensor 6 is integrated at the bottom of the panel 9 inside the front lock body 4.

The above description represents only a preferred embodiment of the invention, intended to facilitate understanding of the method and core concepts of the present application. The scope of protection for the present invention is not limited to the described embodiments but extends to all technical solutions conceived under the inventive principles. It should be noted that for those skilled in the art, improvements and refinements made without departing from the principles of the invention shall also fall within its protective scope.

The present invention comprehensively resolves the shortcomings in prior art regarding the increased spatial demands caused by integrating UWB, NFC, and Bluetooth antennas. By rationally arranging the positions and distances of these antennas within the lock body, it ensures interference-free operation while fulfilling the hardware requirements for smart lock communication functions-all without increasing the lock's overall volume. This advancement provides positive impetus for the evolution of smart locks.

1. A front lock body structure having integrated antennas, comprising:
a front lock body (4) having an external panel;
a PCB board (9) mounted inside the front lock body (4) on the inner side of the panel, equipped with a Bluetooth antenna (1);
a circular NFC antenna (2) arranged on the panel (9);
a UWB antenna (3) positioned above a center of a circular arrangement of the NFC antenna (2);
a card authentication mark (12) marked on the panel at the location of the UWB antenna (3);
wherein the NFC antenna (2) is electrically connected to the PCB board (9); the UWB antenna (3) is mounted on a separate PCB board and electrically connected to the PCB board (7) housing the Bluetooth antenna (1); a distance between the NFC antenna (2) and the Bluetooth antenna (1) ranges from 11 mm to 12 mm, while a distance between the NFC antenna (2) and the UWB antenna (3) is 1 mm to 2 mm; a distance between the Bluetooth antenna (1) and the UWB antenna (3) is 13 mm to 14 mm.

2. The front lock body structure having integrated antennas according to claim 1, wherein a button (11) is installed on the panel outside the circular NFC antenna (2).

3. The front lock body structure having integrated antennas according to claim 2, wherein the Bluetooth antenna (1) is positioned adjacent to the button (11).

4. The front lock body structure having integrated antennas according to claim 1, wherein a lock cylinder (5) is housed below the panel (9) inside the front lock body (4), and a keyhole (10) is provided in the front lock body (4).

5. The front lock body structure having integrated antennas according to claim 4, wherein a transmission rod (8) is internally connected to the lock cylinder (5).

6. The front lock body structure having integrated antennas according to claim 1, wherein a radar sensor (6) is integrated at a bottom of the panel (7) inside the front lock body (4).
